(19) United States
(12) Patent Application Publication
(10) Pub. No.: US 2014/0076587 A1
(43) Pub. Date: Mar. 20, 2014

(54) FIRE RETARDANT DEVICE FOR PROTECTING WOODEN STRUCTURES FROM FIRE

(71) Applicant: OSMOSE HOLDINGS, INC., Buffalo, NY (US)

(72) Inventors: Douglas J. Herdman, Fayetteville, GA (US); Randy Marquardt, Fayetteville, GA (US); Peter-Yu Tham, Stockbridge, GA (US); Thomas Pope, Newnan, GA (US); Robert Butera, Orchard Park, NY (US)

(73) Assignee: Osmose Holdings, Inc., Buffalo, NY (US)

(21) Appl. No.: 13/622,213

(22) Filed: Sep. 18, 2012

(51) Int. Cl. A62C 2/10; A62C 3/02

(52) U.S. Cl. CPC A62C 2/10; A62C 3/0257
USPC 169/48; 29/428; 29/460; 29/402.01; 29/402.09; 29/525.01; 427/372.2; 427/559; 156/212

(57) ABSTRACT

Fire-suppression devices to protect structures from fire damage comprising a fibrous matrix and a fire-retardant composition applied to that matrix. The fire suppression device may be applied to a wooden structure to render at least a portion of that wooden structure resistant to fire.

### TECHNICAL FIELD

The present invention pertains to the use of devices to protect structures from fire damage. More particularly, the present invention is directed towards a fire suppression device comprising a fibrous matrix and a fire-retardant composition applied to that matrix and a fire suppression device applied to a wooden structure to render at least a portion of that wooden structure resistant to fire.

### BACKGROUND

In recent years, the destruction caused by wildfires has become increasingly more severe, and such fires have occurred with greater frequency. To combat the damage caused by these natural disasters, new devices and methods are needed to provide protection from the intense flames of these fires, especially for wooden structures such as utility poles that are particularly vulnerable to wildfires. Grass, shrubs, and other vegetation surrounding the base of a wooden utility pole can rapidly ignite, creating temperatures in excess of 2000° F. and causing the utility poles they surround to burst into flame. The high costs of these poles and other structures have led their owners to seek ways to prevent their investments in such structures from being consumed by these fires.

Recent attempts to prevent fire damage to utility poles and other wooden structures have involved the use of fire retardant formulations, such as Osmose's Fire-guard, that are sprayed or brushed directly onto those wooden structures to provide a coating protecting the structure from fire. Although these directly-applied formulations can provide additional fire resistance to the structures they cover, they have several drawbacks.

First, the direct application of fire retardant formulations is difficult and time-consuming. Fire retardant formulations must be transported into the field and applied to structures with cumbersome and expensive application equipment. Even after such formulations have been applied, they must still be cured before they can provide fire protection. Curing is generally a time-consuming process that renders such in-field treatments impractical when wildfire is present.

Second, the direct adhesion of a fire retardant formulation to a wooden structure can cause additional issues arising from the chemistry of both the wood and the fire-retardant composition. Wooden structures such as utility poles are commonly treated with oil-based preservatives, such as creosote and pentachlorophenol, which can compromise or impair the adhesion of the fire retardant formulation to the wood. This is particularly problematic, when oil-based preservatives bleed from the surface of the wood. Problems with adhesion can lead to fire retardant applications peeling off or otherwise detaching from the treated-wood surface. Such processes may necessitate costly and time-consuming surface preparation before new or additional fire retardant coatings can be applied. Moreover, even if a fire retardant formulation adheres properly to a wooden structure, chemicals from wood preservative compositions in or on the wood may migrate into the fire-retardant coating and adversely affect the chemistry of the fire retardant by compromising its fire resistant properties.

Third, once a fire retardant formulation has been applied to a wooden structure, it can be difficult to remove that formulation from the structure. As a result, costly and laborious removal of fire-retardant coatings and surface preparation is required, if a fire retardant coating becomes physically damaged, over-exposed to fire, or otherwise becomes ineffective.

Some manufacturers have attempted to address the need to protect wooden structures in the field from wildfires by creating devices intended to protect utility poles from the damage caused by these fires. One such example is provided by U.S. Pat. No. 5,746,031, directed to a device constructed from sheets of galvanized metal that are bent into the shapes designed to follow the contours of the ground (“base panel”) and a to surround a cylindrical utility pole (“pole panel”). The base and pole panels are then fastened together with sheet-metal screws to secure the device around the utility pole. By suppressing the growth of vegetation around a utility pole, this metal device deprives fires of necessary fuel, thereby protecting the pole around which it is assembled from fire damage.

Another example of a fire-protection device is disclosed in U.S. Pat. No. 8,151,898, which is directed to a semi-rigid, two-layered device composed of a reflective ceramic material bonded to an expandable graphite compound using a resin. The device is manufactured in a cylindrical shape, and the ends of the device can stretch into an open position to place the device around a utility pole before returning to their original closed cylindrical shape. The outer ceramic layer reflects heat, while the inner graphite compound layer expands when heated to prevent oxygen from reaching the pole's surface.

Like the directly applied fire retardant formulations, these mechanical fire protection devices suffer from drawbacks as well. Metal fire protection devices are heavy, making it costly and difficult to transport these devices to remote field locations. Moreover, the rigid shapes of such mechanical devices make them only useful for protecting a structure of a particular shape and size, and necessitates a specialized design of a series of devices and fitting to particular structures.

In addition to the drawbacks caused by the heavy, rigid nature of these mechanical fire protection devices, the use of such devices can lead to problems with the structures they are meant to protect. Metallic or otherwise non-breathable devices can trap moisture against utility poles and other wooden structures, leading to accelerated decay. Moreover, such devices may also prevent utility personnel from gaffing (climbing a wooden utility pole using gaff hooks or gaff spikes) the pole in order to inspect and repair any damage that pole has sustained. Such devices also impair boring or drilling into a wooden structure which may be required to repair, modify, alter or treat a wood structure with preservatives or fumigants.

As discussed above, existing fire retardant formulations and existing fire protection devices suffer from many deficiencies. Existing fire retardant formulations suffer from a time-consuming and cumbersome application process, problems with adhesion to wooden structures, and difficulties with removal of the formulations from structures once those formulations have been applied. Existing fire protection devices are limited to use with the specific structure for which they are shaped, are difficult and costly to transport, and can prevent utility personnel from accessing and gaffing the structure. As a result, there is a need for a fire suppression device that does not suffer from the drawbacks common to these existing fire protection formulations and devices. The present invention, which is described in detail below, solves the need in the art for such a device.

### SUMMARY OF THE INVENTION

The present invention is directed, in certain aspects, to fire suppression devices essentially free of water for protecting structures from fire comprising a fibrous matrix having dimensions of between about 3 and about 25 feet along a first axis and between about 1 and about 5 feet along a second axis, wherein the fibrous matrix is breathable, and a fire-retardant composition essentially free of any volatile organic compound comprising at least one fire retardant, applied to at least one face of the fibrous matrix in an amount effective to render the fibrous matrix resistant to fire, the fire suppression device being sufficiently flexible to conform to a contoured structure.

In certain aspects of the invention, the fibrous matrix is selected from the group consisting of woven fibrous materials, non-woven fibrous materials, knitted fibrous materials, and fabrics.

In certain aspects of the invention, the devices described herein are essentially free of resin.

In certain aspects of the invention, the fibrous matrix is selected from the group consisting of natural and synthetic fibers. In further aspects, the synthetic fibers are fiberglass.

In certain aspects of the invention, the fire-retardant composition is latex-based.

In certain aspects of the invention, the at least one fire retardant is selected from the group consisting of minerals, organohalogens, and organophosphates. In further aspects of the invention, the minerals include zinc borate, aluminum oxide, glass oxide, and mullite.

In certain aspects of the invention, the devices may comprise a pigment. In further aspects of the invention, the pigment is temperature sensitive.

In certain aspects of the inventions, the devices are gaffable.

In certain aspects of the invention, the devices further comprise a flammable structure. In further aspects of the invention, the flammable structure comprises wood. In still further aspects of the invention, the flammable structure comprises at least one utility pole. In further aspects of the invention, the devices described herein comprise mechanical fasteners. In still further aspects of the invention, the mechanical fasteners are selected from the group consisting of nails, staples, screws, tacks, and spikes. In further aspects of the invention, the devices described herein comprise one or more adhesives. In further aspects of the invention, the devices described herein render all or a portion of the flammable structure resistant to fire.

The present invention is directed, in certain aspects, to methods for preparing a fire suppression device essentially free of water for protecting a structure from fire, comprising the steps of providing a fibrous matrix, providing a fire-retardant composition comprising at least one fire retardant and an aqueous carrier, applying the fire-retardant composition to at least one face of the fibrous matrix in an amount effective to render the fibrous matrix resistant to fire, and curing the device to prepare the fire suppression device.

In certain aspects of the invention, the fire-retardant composition is viscous.

In certain aspects of the invention, the fire-retardant composition has a boiling point of at least 212 degrees Fahrenheit.

In certain aspects of the invention, the fire-retardant composition is applied using a technique selected from the group consisting of spraying, brushing, and rolling.

In certain aspects of the invention, the methods for preparing a fire suppression device essentially free of water for protecting a structure from fire further comprise the step of applying mechanical fasteners to the device.

In certain aspects of the invention, the fire-retardant composition is applied in one or more layers. In further aspects of the invention, the layers are about 1/32 to about ¼ inches thick.

In certain aspects of the invention, the device is cured using a heating source. In further aspects of the invention, the heating source is selected from the group consisting of an oven, a heat lamp, and an infrared lamp. In certain aspects of the invention, the device is cured using forced air.

The present invention is directed, in certain aspects, to methods for applying a fire suppression device essentially free of water to a structure, comprising contacting the device to the structure, conforming the device to the shape of the structure, and fastening the device to the structure, wherein the device comprises a fibrous matrix and a fire-retardant composition comprising at least one fire retardant and an aqueous carrier, the fire-retardant composition is applied to at least one face of the fibrous matrix in an amount effective to render the fibrous matrix resistant to fire, and wherein the method renders all or a portion of the structure resistant to fire.

In certain aspects of the inventive methods for applying a fire suppression device essentially free of water to a structure, the methods further comprise the step of puncturing the device with an object selected from the group consisting of a gaff, a bore, a drill, and a knife. In further aspects of the invention, the methods further comprise the step of applying preservatives or fumigants to the structure.

In certain aspects of the inventive methods for applying a fire suppression device essentially free of water to a structure, the methods further comprise the step of repairing the device. In further aspects of the invention, repairing the device consists of patching the device or applying additional amounts of the fire-retardant composition to the device.

In certain aspects of the inventive methods for applying a fire suppression device essentially free of water to a structure, the device does not adhere directly to the structure.

In certain aspects of the invention, the device changes color when exposed to fire.

In certain aspects of the invention, the methods for applying a fire suppression device essentially free of water to a structure further comprise fastening the device to the structure using mechanical fasteners. In certain aspects of the invention, the device is fastened to the structure using adhesives.

### DETAILED DESCRIPTION OF THE INVENTION

The present invention is directed towards a fire suppression device utilized for protecting a structure from fire, as well as towards the methods of preparing and using such a fire suppression device. One aspect of the invention is a fire suppression device for protecting a structure from fire, comprising a fibrous matrix and a fire-retardant composition applied to at least one face of that fibrous matrix. Another aspect of the invention is a method for preparing a fire suppression device, comprising the steps of providing a fibrous matrix, providing a fire-retardant composition comprising at least one fire retardant and an aqueous carrier, applying said fire-retardant composition to at least one face of said fibrous matrix, and curing the device. A third aspect of the invention is a method for applying a fire suppression device to a structure, comprising the steps of contacting and conforming the device to the shape of the structure, and then fastening the device to the structure, rendering at least a portion of the structure resistant to fire.

To ensure clarity in the following detailed description, the following definitions are provided.

In one aspect of the invention, a fire-retardant composition comprising at least one fire retardant and an aqueous carrier is applied to a fibrous matrix. This fire-retardant composition is then cured, wherein the aqueous carrier evaporates from the fibrous matrix. As used herein, the device comprising the fibrous matrix and the cured fire-retardant composition is “essentially free of water”, after the evaporation of the aqueous carrier. As used herein, “curing” refers to the process of removing solvent, liquid or aqueous carrier from the fire-retardant composition applied to the fibrous matrix and “cured” means the device after solvent, liquid or aqueous carrier has been removed, such that the device is “essentially water free” as that term is used herein.

As used herein, the term “breathable” refers to a material that is sufficiently porous as to be permeable to water vapor.

As used herein, the phrase “fibrous matrix” refers to any fiber-containing material, but specifically excludes materials from the group consisting of sheet metals and ceramics.

As used herein, the phrase “resistant to fire” refers to a material that was tested in accordance with ASTM Test Method E-84 and that was determined to have Class A fire resistance in accordance with the definition contained in Section 803.1 of the International Building Code.

In one aspect of the present invention, a fire suppressant device comprises a sheet having dimensions of between about 3 and about 25 feet along a first axis of the sheet and between about 1 and about 5 feet along a second axis of the sheet. It would be readily apparent to one skilled in the art, however, that the present invention is not limited to these particular dimensions, and that sheets of other sizes and shapes could be utilized for the fire suppressant device. In one aspect of the invention, the fire suppressant device could be custom-sized to a particular shape and set of dimensions that were specified by a customer. Moreover, it would also be readily apparent to one of ordinary skill that the device is not limited to the form of a sheet, but could also comprise a mat, a wrap, a cover, a bandage, or the like.

The fire suppressant device of the present invention comprises a fibrous matrix. In one aspect of the present invention, the fibrous matrix is comprised of fiberglass. It would be readily apparent to one skilled in the art, however, that the present invention is not limited to the use of fiberglass as the fibrous matrix material. Indeed, it would be readily apparent to one skilled in the art that the fibrous matrix of the present invention could be comprised of any material selected from the group consisting of woven fibrous materials, non-woven fibrous materials, knitted fibrous materials, fabrics, textiles, and/or other suitable fibrous matrices, and could be comprised of natural fibers and/or synthetic fibers.

In addition to the fibrous matrix, the device of one aspect of the present invention also comprises a fire-retardant composition that is applied to at least one face of the fibrous matrix. It would be readily apparent to one skilled in the art that the fire-retardant composition could be applied to the fibrous matrix using a number of different methods, including but not limited to spraying, dipping, brushing, rolling, painting, and the like, such that one or multiple faces of the fibrous matrix contain fire retardant composition or such that the fibrous matrix is impregnated with a fire retardant composition.

The fire-retardant composition is applied in one or more layers to the at least one face of the fibrous matrix. In one aspect of the present invention, the one or more layers may be of uniform thickness of about 1/32 to ¼ inches thick. In another aspect of the invention, the fire-retardant composition is applied in a ⅛ inch thick layer. It would be readily apparent to one skilled in the art, however, that the applied layers of fire-retardant composition could be of any thickness, as long as that thickness was sufficient to render the fibrous matrix resistant to fire.

The fire-retardant composition to be applied to the fibrous matrix is a water-based formulation comprising at least one fire retardant and an aqueous carrier. In one aspect of the invention, the at least one fire retardant(s) contained within the composition are selected from one or more members of the group consisting of zinc borate, aluminum oxide, glass oxide, mullite and the like.

It will be readily apparent to one skilled in the art that a variety of different fire retardants could be used in different aspects of the invention. Such alternative fire retardants include minerals such as aluminum hydroxide, magnesium hydroxide, hydrates, and borates. Borates for use in the fire-retardant composition include boric acid, sodium borates such as sodium tetraborate decahydrate, sodium tetraborate pentahydrate, and disodium octaborate tetrahydrate, potassium borates, and metal borate compounds such as calcium borate, borate silicate, aluminum silicate borate hydroxide, silicate borate hydroxide fluoride, hyrdroxide silicate borate, sodium silicate borate, calcium silicate borate, aluminum borate, boron oxide, magnesium borate, iron borate, copper borate, and zinc borate.

Other possible alternative fire retardants for use in the present invention include organohalogen compounds such as organochlorines and organobromines, as well as organophosphorus compounds such as organophosphates. In one aspect of the invention, the fire-retardant composition is comprised of a guanidine phosphate, a boron compound, and water. The guanidine phosphate compound can be selected from the group consisting of mono-guanidine phosphate, di-guanidine phosphate, and tri-guanidine phosphate.

It will be readily apparent to one skilled in the art that the one or more fire retardants could be used in amounts between 1 and 50% by weight or between 1 and 25% by weight or between 1 and 20% by weight or between 1 and 10% by weight or between 1 and 5% by weight. The fire-retardant composition may comprise between 0-20% by weight zinc borate, 0-30% by weight aluminum oxide, 0-10% by weight glass oxide, and/or 0-10% by weight mullite. In another aspect of the invention, the fire retardant compositions suitable for use in the invention herein comprise between 5 and 10% by weight zinc borate. In another aspect of the invention, the fire retardant compositions suitable for use in the invention herein comprise between 10 and 20% by weight aluminum oxide. In another aspect of the invention, the fire retardant composition comprises between 1 and 5% by weight glass oxide. In another aspect of the invention, the fire retardant compositions suitable for use in the invention herein comprise between 1 and 5% by weight mullite.

In one aspect of the invention, the aqueous carrier is water. In another aspect of the invention, the aqueous carrier is a latex-based carrier, but it would be readily apparent to one of ordinary skill that an equivalent aqueous carrier could be used as well. In aspects of the invention, the fire-retardant compositions of the invention has a boiling point of at least 212° F.

In one aspect of the present invention, the fire-retardant composition to be applied to the fibrous matrix is essentially free of volatile organic compounds. As would be readily apparent to one skilled in the art, volatile organic compounds include formaldehyde, benzene, methylene chloride, perchlorothylene, chlorofluorocarbons, ethyl acetate, glycol ethers, acetone, and other organic compounds having a boiling point less than or equal to 250° C. measured at a standard atmospheric pressure of 101.3 kPa. In one aspect of the invention, the fire-retardant composition comprises less than 0.05, 0.1, 0.5, 1, 2, 5, 10, 15, 20, 25, 30, 35, 40 or 45% by volume volatile compounds. In another aspect of the invention, the fire-retardant composition comprises less than 0.1% formaldehyde.

In one aspect of the present invention, the fire-retardant composition to be applied to the fibrous matrix is essentially free of resin. It would be readily apparent to one skilled in the art that resins comprise both natural and synthetic resins, including but not limited to plant resin, epoxy resin, casting resin, acetal resin, polyester resin, and other resins. In one aspect of the invention, the fire-retardant compositions comprise less than 0.05, 0.1, 0.5, 1, 2, 5, 10, 15, 20, 25, 30, 35, 40 or 45% by weight resins. In another aspect of the invention, the device is essentially free of resins or the device comprises less than 0.05, 0.1, 0.5, 1, 2, 5, 10, 15, 20, 25, 30, 35, 40 or 45% by weight resins.

In one aspect of the present invention, the fire-retardant composition applied to the fibrous matrix is in the form of a semi-viscous paste. It would be readily apparent to one skilled in the art, however, that the fire-retardant composition could be provided in other forms with varying degrees of viscosity, such as pastes, gels, foams, and the like.

After being applied to the fibrous matrix, the fire-retardant composition is cured. During the process of curing, essentially all of the aqueous carrier is removed from the applied fire-retardant composition by evaporation. In one aspect of the invention, essentially all of the water is removed from the device. In one aspect of the invention, the fire-retardant composition applied to the fibrous matrix is cured using an oven. However, it would be readily apparent to one skilled in the art that the applied fire-retardant composition could be cured using other equivalent means, such as other heat sources including heat lamps, infrared lamps, and electric resistance wires. It would also be readily apparent to one skilled in the art that the applied fire-retardant composition can be cured using either natural air-drying or forced air-drying to evaporate the aqueous carrier from the applied fire-retardant composition.

After curing, in one aspect of the invention, the fire-retardant composition is essentially free of water. In one aspect of the invention, after curing, the moisture content of the fire suppression device is less than 0.5, 1, 2, 5, 10, 15 or 20% by weight. In another aspect of the present invention, after curing, the moisture content of the fire suppression device is between 0.5 and 5%, 1 and 5%, 1 and 10%, or 5% and 10% by weight.

Once the fire-retardant composition has cured, the device of the present invention is ready for use. The device is easily transportable to locations in the field, and, since the device has already been cured, it can be quickly applied to structures in the field without having to wait for the device to cure after that device has been applied. It would be readily apparent to one skilled in the art that the ease of transporting the device and elimination of curing time in the field makes the device ideal for use in remote, hard-to-reach locations in the field, as well as for situations in which fire protection is urgently needed, such as in the face of a fast-approaching wildfire.

After the device of the present invention has been prepared for use in the field, it can be applied to a structure to render at least a portion of that structure resistant to fire. In one aspect of the invention, the structure is a flammable wooden structure. It would be readily apparent to one skilled in the art, however, that the present invention is not limited to the protection of wooden structures, but could be used to provide fire resistant protection to structures composed of any flammable material, and could also be used to lend additional fire resistance to structures composed of non-flammable materials, for example structures made of metal or composite materials.

The device of the present invention is applied to a structure to be protected by contacting the device to that structure and then conforming the device to the shape and/or contours of that structure. In one aspect of the invention, the structure to be protected is at least one cylindrically shaped utility pole, to which the device is contacted and conformed. However, it will be readily apparent to one skilled in the art that the device of the present invention is not limited to application on pole-shaped structures, but can be contacted and conformed to any planar or curved structure. Such planar or curved structures include trees, walls, roofs, and other equivalent structures and surfaces.

After contacting and conforming the device to the shape of the structure to be protected, the device is then fastened to the structure or itself so that it is secured to the structure. In one aspect, the device does not adhere directly to the structure, but is fastened to that structure using mechanical fasteners such as nails. It will be readily apparent to one skilled in the art that any type of mechanical fasteners, including nails, staples, spikes, tacks, screws, and the like, could be used to fasten the device to a structure in need of protection. Furthermore, one skilled in the art would also recognize that non-mechanical fasteners, such as adhesives, could also be used to fasten the device to the structure in need of protection.

After contacting, conforming, and fastening the device of the present invention to a structure, the device then renders that structure resistant to fire. Resistance to fire may be measured and determined using the ASTM International Standard Test Method for Surface Burning Characteristics of Building Materials, also known as ASTM E-84, and incorporated herein in its entirety. ASTM E-84 uses a Steiner tunnel test to measure the growth of flame and the emission of smoke from a horizontal sample of the material to be tested. A flame-spread index and smoke-developed index are then calculated from the test's results in order to determine the material's resistance to fire. Both the flame-spread index and smoke-developed index are determined along a scale where the flame spread and smoke development of asbestos-cement has a value of 0, and the flame spread and smoke development of red oak has a value of 100. Section 803.1 of the International Building Code, incorporated herein in its entirety, states that materials judged to have Class A fire resistance must have an E-84 flame-spread index of less than 25 and a smoke-developed index of less than 450.

In one aspect of the invention, the fire suppression device is resistant to fire, having an E-84 flame-spread index of less than 25 and/or smoke-developed index of less than 450. In another aspect of the invention, the ASTM E-84 flame-spread index of the fire suppression device is less than 20 and/or the smoke-developed index of the device is less than 100. In yet another aspect of the invention, the ASTM E-84 flame-spread index of the fire suppression device is lower than 10 and/or the smoke-developed index of the device is less than 30. In that aspect, the fire suppression device has a flash point of greater than 212° F. or, alternatively, does not have or is not characterized by a flash point.

In addition to rendering at least part of the structure to which it is applied resistant to fire, the device of the present invention can also provide other beneficial properties to the structure to which the device is applied. In one aspect, the fire suppressant device of the present invention provides additional resistance to ultraviolet rays to the structure to which it is applied. In another aspect, the fire suppressant device provides additional tensile strength to provide physical support to the structure. In yet another aspect, the fire suppressant device provides a barrier to protect the structure from physical damage from the weather, insects, and borers, such as woodpeckers.

In one aspect of the present invention, the device of the present invention is breathable, being sufficiently porous as to be permeable to water vapor. In this aspect of the invention, the breathability of the fire suppression device allows water vapor to pass through the device, allowing moisture to enter and exit the structure the device as needed to reduce decay of the structure.

In one aspect of the present invention, the fire suppression device also comprises a pigment. In a particular aspect of the invention, that pigment renders the device a gray color. It would be readily apparent to one skilled in the art, however, that the pigment could consist of any desired color, for example green, brown, black or other shades of color. In one aspect of the present invention, the pigment of the device is temperature sensitive. In a particular aspect of the invention, the pigment reacts to increased temperatures by changing color when exposed to fire, specifically by changing from an initial gray color to a darker, charred color. It would be readily apparent to one skilled in the art that the color of the pigment could change to a variety of different colors in response to exposure to fire.

Once the fire suppression device is applied to the structure, in one aspect of the present invention, the device is gaffable. The device can be punctured by gaff spikes, gaff hooks, or equivalent climbing equipment, allowing a person wearing that equipment to ascend the structure. In one aspect of the invention, the gaffability of the device allows utility personnel wearing gaff spikes or gaff hooks to ascend a wooden utility pole to which the device of the present invention has been applied. It would be readily apparent to one skilled in the art, however, that the gaffability of the device is not limited to allowing personnel to climb utility poles, and that the device of the present invention would allow one to ascend wooden structures of any shape or size by using gaff hooks or gaff spikes.

In another aspect of the present invention, the device of the present invention can be punctured by knives, bores, drills, or equivalent mechanical devices to reach the structure the device, allowing personnel to apply treatments to or inspect the structure without removing the device of the present invention. In some aspects of the invention, puncturing the device allows personnel to apply preservatives or fumigants to an wooden structure, as well as to inspect the current state of the structure. In a particular aspect of the invention, the device can be cut away from a region of an structure where a fumigant plug had previously been applied to the structure, in order to remove the previously applied fumigant plug and apply a new plug.

In an aspect of the present invention, once damaged, the fire suppression device of the present invention can be repaired. It would be readily apparent to one skilled in the art that damage to a fire suppression device can occur from a variety of sources: maintenance personnel cutting or puncturing the fire suppression device to inspect an structure or to apply remedial preservative treatments, natural damage from wind and precipitation, damage resulting from woodpeckers, repeated exposure to fire, and other sources of damage. In one aspect of the invention, repairing the device comprises cutting away the damaged region of the device, and patching that damaged or punctured region of the device with a patch of the fibrous matrix to which the fire-retardant composition has been applied and cured.

In another aspect of the present invention, repairing the device comprises cutting away the damaged region of the device, applying additional layers of the fire-retardant composition to that region of the device, and curing the newly added layers of the fire-retardant composition. It would be readily apparent to one skill in the art that the present invention is not limited to these methods of repairing the device, and that other equivalent methods could be used to repair the device of the present invention.

In addition to being easily attachable to a structure to be protected, and repairable, the device of the present invention can also be removed from the structure to which it is applied. In one aspect of the present invention, removing the mechanical fasteners from the device allows the device to be detached from the structure to which it was applied. It would be readily apparent to one skilled in the art that the present invention is not limited to this method of removing the device from an structure, and that other methods could be used to remove the device of the present invention from the structure to which it was fastened.

The following Examples are only illustrative. It will be readily seen by one of ordinary skill in the art that the present invention fulfills all of the objectives set forth above. After reading the foregoing specification, one of ordinary skill will be able to effect various changes, substitutions of equivalents, and various other aspects of the invention as broadly disclosed therein. It is therefore intended that the protection granted herein be limited only by the definition contained in the appended claims and equivalents thereof.

### EXAMPLES

### Example 1

### Method of Preparing a Fire Suppression Device

A fibrous matrix, consisting of a fiberglass rectangle having dimensions of between about 3 and about 25 feet along a first axis of the fiberglass and between about 1 and about 5 feet along a second axis of the fiberglass is provided, and an aqueous fire-retardant composition comprising latex as an aqueous carrier and at least one fire retardant is applied to one face of the fiberglass.

The water-soluble compounds contained in the latex-based fire-retardant composition applied to the fiberglass comprise 10-20% 2-propenoic acid polymer, 10-2% aluminum oxide, 10-20% frits, 1-5% glass oxide, 1-5% magnesium aluminum silicate, 1-5% mullite, 1-5% vinyl acetate polymer, 5-10% zinc borate, and less than 1% of both quartz and titanium dioxide. The composition has a white color and a mild latex odor. The fire-retardant composition is essentially free of any volatile organic compound, comprising less than 0.1% formaldehyde.

The fire-retardant composition is sprayed or brushed onto one face of the fiberglass in a uniform ⅛ inch thick layer. After the fire-retardant composition is applied to the fiberglass, the fiberglass, now coated with the layer of fire-retardant composition, is placed into an oven to cure. Once the aqueous carrier has evaporated, the fire suppression device is essentially free of water and is ready for use.

### Example 2

### Method of Using a Fire Suppression Device

A fire suppression device is contacted to a wooden utility pole, conformed to the surface of that utility pole, and then fastened to the utility pole using mechanical fasteners such as tacks or nails. The fire suppression device renders the portion of the wooden utility pole's surface that it covers resistant to fire.

The fire suppression device applied to the utility pole is initially colored gray, green, or brown. The device changes color to a dark, charred color when exposed to fire, indicating to utility personnel that the device has been exposed to flame and that the fire suppression device as well as the wooden utility pole may have suffered damage.

What is claimed is:

1. A fire suppression device essentially free of water for protecting a structure from fire comprising:
a fibrous matrix having dimensions of between about 3 and about 25 feet along a first axis and between about 1 and about 5 feet along a second axis, wherein said fibrous matrix is breathable; and
a fire-retardant composition essentially free of any volatile organic compound comprising at least one fire retardant, applied to at least one face of said fibrous matrix in an amount effective to render said fibrous matrix resistant to fire;
said fire suppression device being sufficiently flexible to conform to a contoured structure.

2. The fire suppression device of claim 1, wherein said fibrous matrix is selected from the group consisting of woven fibrous materials, non-woven fibrous materials, knitted fibrous materials, and fabrics.

3. The fire suppression device of claim 1, wherein said device is essentially free of resin.

4. The fire suppression device of claim 1, wherein said fibrous matrix is selected from the group consisting of natural fibers and synthetic fibers.

5. The fire suppression device of claim 4, wherein said synthetic fibers are fiberglass.

6. The fire suppression device of claim 1, wherein said composition is latex-based.

7. The fire suppression device of claim 1, wherein said at least one fire retardant is selected from the group consisting of minerals, organohalogens, and organophosphates.

8. The fire suppression device of claim 7, wherein said minerals include zinc borate, aluminum oxide, glass oxide, and mullite.

9. The fire suppression device of claim 1, further comprising a pigment.

10. The fire suppression device of claim 9, wherein said pigment is temperature sensitive.

11. The fire suppression device of claim 1, wherein said device is gaffable.

12. The fire suppression device of claim 1, further comprising a flammable structure.

13. The fire suppression device of claim 12, wherein said flammable structure comprises wood.

14. The fire suppression device of claim 13, wherein said flammable structure comprises at least one utility pole.

15. The fire suppression device of claim 12, further comprising mechanical fasteners.

16. The fire suppression device of claim 15, wherein said mechanical fasteners are selected from the group consisting of nails, staples, screws, tacks, and spikes.

17. The fire suppression device of claim 12, further comprising one or more adhesives.

18. The fire suppression device of claim 12, wherein said device renders all or a portion of said flammable structure resistant to fire.

19. A method for preparing a fire suppression device essentially free of water for protecting a structure from fire, comprising the steps of:
providing a fibrous matrix;
providing a fire-retardant composition comprising at least one fire retardant and an aqueous carrier;
applying said fire-retardant composition to at least one face of said fibrous matrix in an amount effective to render said fibrous matrix resistant to fire; and
curing said device to prepare said fire suppression device.

20. The method of claim 19, wherein said fire-retardant composition is viscous.

21. The method of claim 19, wherein said fire-retardant composition has a boiling point of at least 212 degrees Fahrenheit.

22. The method of claim 19, wherein said fire-retardant composition is applied using a technique selected from the group consisting of spraying, brushing, and rolling.

23. The method of claim 19, further comprising the step of applying mechanical fasteners to said device.

24. The method of claim 19, wherein said fire-retardant composition is applied in one or more layers.

25. The method of claim 24, wherein said layers are about 1/32 to about ¼ inches thick.

26. The method of claim 19, wherein said device is cured using a heating source.

27. The method of claim 26, wherein said heating source is selected from the group consisting of an oven, a heat lamp, and an infrared lamp.

28. The method of claim 19, wherein said device is cured using forced air.

29. A method for applying a fire suppression device essentially free of water to a structure, comprising:
contacting said device to said structure;
conforming said device to the shape of said structure;
fastening said device to said structure;
wherein said device comprises a fibrous matrix and a fire-retardant composition comprising at least one fire retardant and an aqueous carrier, said fire-retardant composition applied to at least one face of said fibrous matrix in an amount effective to render said fibrous matrix resistant to fire; and
wherein said method renders all or a portion of said structure resistant to fire.

30. The method of claim 29, further comprising the step of puncturing said device with an object selected from the group consisting of a gaff, a bore, a drill, and a knife.

31. The method of claim 30, further comprising the step of applying preservatives or fumigants to said structure.

32. The method of claim 29, further comprising the step of repairing said device.

33. The method of claim 32, wherein repairing said device consists of patching said device or applying additional amounts of said fire-retardant composition to said device.

34. The method of claim 29, wherein said device does not adhere directly to said structure.

35. The method of claim 29, wherein said device changes color when exposed to fire.

36. The method of claim 29, wherein said device is fastened to said structure using mechanical fasteners.

37. The method of claim 29, wherein said device is fastened to said structure using adhesives.
